(19) United States
(12) Patent Application Publication
(10) Pub. No.: US 2025/0261754 A1
(43) Pub. Date: Aug. 21, 2025

(54) RACKING SYSTEM AND METHOD

(71) Applicant: Montel inc., Montmagny (CA)

(72) Inventors: Dominic Simard, Montmagny (CA); Carl-Frédéric Chouinard, Saint-Paul-de-Montminy (CA); Stéphane Lanteigne, Montmagny (CA)

(21) Appl. No.: 19/052,792

(22) Filed: Feb. 13, 2025

Related U.S. Application Data
(60) Provisional application No. 63/554,679, filed on Feb. 16, 2024.

(51) Int. Cl. A47B 83/00; A47B 47/00

(52) U.S. Cl. CPC A47B 83/00; A47B 47/00

(57) ABSTRACT

There is provided a racking system comprising: at least two rows of rack configurable in a spaced-apart and substantially parallel configuration to define a walking space in between; a platform assembly; and a ladder engageable with the platform assembly. The platform assembly comprises: a walking platform, platform mounting brackets securable to vertically-extending posts of the rows of rack, and post couplers provided on each one of the lateral sections of the frame of the walking platform in each one of the lateral end regions. The post couplers are engageable with a respective one of platform couplers of the platform mounting brackets to configure the walking platform in a substantially horizontal and walkable configuration. There is also provided a method to mount a walking platform to a racking system.

### TECHNICAL FIELD OF THE INVENTION

The technical field relates to a platform for allowing a user to access upper shelves in racks such as storage racks, interior growing or cultivation racks of a racking system. It also relates to a racking system having at least one detachable platform and, optionally, a detachable ladder to access the platform.

### BACKGROUND

Racking systems include a plurality of rows of racks, horizontally spaced-apart from one another, each one of the racks having a frame supporting vertically spaced-apart shelves. The racking system can be a fixed racking system wherein racks are disposed side-by-side with an aisle provided between consecutive ones of the racks. The racking system can also be a mobile racking system, wherein at least one of the racks is mobile, e.g., it can be translated with respect to the other racks of the system.

In mobile racking systems, the racks can be supported and displaced on rails. Therefore, consecutive one of the racks can be configured in a collapsed configuration, wherein they contact each other, or in a spaced-apart configuration, wherein an aisle is defined inbetween to allow access to a person desiring to recuperate or store an article stored in the racks that are on either side of the aisle. Therefore, the horizontal stacking of the racks can be rearranged to define an aisle between selected two of the racks. Consequently, minimal volume is occupied by the mobile rack system since a permanent aisle is not required between each two consecutive racks.

To further optimize storage space, racks extend vertically often well above human height, requiring a ladder or a temporary scaffold to access articles stored in the upper shelves or retrieve articles therefrom. However, ladders can be unstable and temporary scaffold can require time to be erected and disassembled.

In view of the above, there is a need for a system to relatively quickly and easily provide access to upper shelves of a rack system and which can be relatively quickly detachable/removable, if required, which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a racking system that comprises at least two rows of rack and a platform assembly. The at least two rows of rack are configurable in a spaced-apart and substantially parallel configuration to define a walking space in between. Each one of the racks comprises a first side and a second side, opposed to the first side, a first pair of vertically-extending posts located on the first side and a second pair of vertically-extending posts located on the second side. The platform assembly comprises walking platform, platform mounting brackets and post couplers. The walking platform has a frame with longitudinal sections and lateral sections and a walking panel mounted to the frame and defining a walking surface. Each one of the lateral sections has opposed lateral end regions. The platform mounting brackets are securable to the vertically-extending posts of the first pair and the second pair on a side delimiting the walking space at a same height. Each one of the platform mounting brackets has a platform coupler. The post couplers are provided on each one of the lateral sections of the frame of the walking platform in each one of the lateral end regions. The post couplers are engageable with a respective one of the platform couplers of the platform mounting brackets to configure the walking platform in a substantially horizontal and walkable configuration.

In accordance with an embodiment, at least one of the at least two rows of rack is horizontally displaceable towards and away from the other one of the at least two rows of rack.

In accordance with an embodiment, the at least two rows of rack are selectively configurable in a collapsed configuration wherein consecutive ones of the rows of rack are in contact and a horizontally spaced-apart configuration wherein the walking space is defined between consecutive ones of the rows of rack.

In accordance with an embodiment, the vertically-extending posts have a plurality of vertically-spaced apart mounting apertures extending therethrough and the platform assembly further comprises bracket fasteners and the platform mounting brackets are detachably secured to the vertically-extending posts by inserting the bracket fasteners into respective ones of the mounting apertures defined in the vertically-extending posts.

In accordance with an embodiment, the platform mounting brackets are substantially U-shaped and comprise two flanges superposable to opposed sides of a respective one of the vertically-extending posts and a joining section connecting the two flanges together.

In accordance with an embodiment, each one of the platform couplers comprises a protruding male member and each one of the post coupler comprises a post coupling aperture extending through a respective one of the lateral sections of the frame of the platform. The post coupling aperture is open on a lower edge of the respective one of the lateral sections and engageable by a corresponding one of the protruding male member.

In accordance with an embodiment, a first one of the post coupling apertures in a first one of the lateral end regions is substantially L-shape and comprises an insertion segment opened on the lower edge and a locking segment extending towards a lateral end of the first lateral end region.

In accordance with an embodiment, a second one of the post coupling apertures in a second one of the lateral end regions defines an oblique angle with the lower edge of the respective one of the lateral sections, having a closed end closer to a lateral end of the second lateral end region.

According to another general aspect, there is provided a method for detachably mounting a walking platform to a racking system that comprises at least two rows of racks configurable in a spaced-apart and substantially parallel configuration to define a walking space in between. The method comprises: securing platform mounting brackets to vertically-extending posts of a respective frame of the rack of a first one of the rows and a respective frame of the rack of a second one of the rows, the vertically-extending posts of the first row and the second row delimitating the walking space, the platform mounting brackets being mounted at a same height, engaging first lateral end regions of lateral sections of a frame of the walking platform with the platform mounting brackets secured to the vertically-extending posts of the first row, pivoting second lateral end regions of the lateral sections of the frame of the walking platform above the platform mounting brackets secured to the vertically-extending posts of the second row walking platform and engaging the second lateral end regions of the lateral sections of the frame of the walking platform with the platform mounting brackets secured to the vertically-extending posts of the second row to configure the walking platform in a substantially horizontal and walkable configuration.

According to another general aspect, there is provided a racking system that comprises at least two rows of rack, a platform assembly and a ladder. The at least two rows of rack are configurable in a spaced-apart and substantially parallel configuration to define a walking space in between. Each one of the racks comprises a first side and a second side, opposed to the first side, a first pair of vertically-extending posts located on the first side and a second pair of vertically-extending posts located on the second side. The platform assembly comprises a walking platform and at least one ladder coupler. The walking platform has a frame with longitudinal sections and lateral sections and a walking panel mounted to the frame and defining a walking surface. Each one of the lateral sections has opposed lateral end regions. The walking platform is detachably securable to the vertically-extending posts of the first pair and the second pair on a side delimiting the walking space and configurable in a substantially horizontal and walkable configuration. The at least one ladder coupler is provided on at least one of the lateral sections of the frame of walking platform. The ladder comprises a frame with a platform mounting side and a platform coupler detachably engageable with the at least one ladder coupler when the platform is configured in the substantially horizontal and walkable configuration.

In accordance with an embodiment, at least one of the at least two rows of rack is horizontally displaceable towards and away from the other one of the at least two rows of rack.

In accordance with an embodiment, the at least two rows of rack are selectively configurable in a collapsed configuration wherein consecutive ones of the rows of rack are in contact and a horizontally spaced-apart configuration wherein the walking spaced is defined between consecutive ones of the rows of rack.

In accordance with an embodiment, the vertically-extending posts have a plurality of vertically-spaced apart mounting apertures extending therethrough and the platform assembly further comprises bracket fasteners and the platform mounting brackets are detachably secured to the vertically-extending posts by inserting the bracket fasteners into respective ones of the mounting apertures defined in the vertically-extending posts.

In accordance with an embodiment the at least one ladder coupler comprises two ladder couplers. Each one comprises a ladder coupling opening extending through the at least one of the lateral sections of the frame in a respective lateral end region thereof and the platform coupler comprises male members protruding from the plateform mounting side of the frame in an upper section thereof. The male members are selectively engageable and disengageable with a corresponding one of the ladder coupling openings.

In accordance with an embodiment, each one of the ladder coupling openings is pyriform.

According to a general aspect, there is provided a racking system comprising at least two rows of racks, a platform assembly. The at least two rows of racks are configurable in a spaced-apart and substantially parallel configuration to define a walking space in between. Each one of the racks comprises a first side and a second side, opposed to the first side, a first pair of vertically-extending posts located on the first side and a second pair of vertically-extending posts located on the second side. The platform assembly comprises a walking platform, platform mounting brackets and post couplers. The walking platform has a frame with longitudinal sections and lateral sections and a walking panel mounted to the frame and defining a walking surface. Each one of the lateral sections has opposed lateral end regions. The platform mounting brackets are securable to the vertically-extending posts of the first pair and the second pair on a side delimiting the walking space at a same height. Each one of the platform mounting brackets has a platform coupler. The post couplers are provided on each one of the lateral sections of the frame of the walking platform in each one of the lateral end regions. Each one of the post couplers comprises a post coupling aperture extending through a respective one of the lateral sections of the frame of the walking platform. The post couplers are engageable with a respective one of the platform couplers of the platform mounting brackets to configure the walking platform in a substantially horizontal and walkable configuration, wherein at least one of the post coupling apertures of each one of the lateral sections of the frame is open on a lower edge thereof.

In accordance with an embodiment, at least one of the at least two rows of racks is horizontally displaceable towards and away from the other one of the at least two rows of racks and the at least two rows of racks are selectively configurable in a collapsed configuration wherein consecutive ones of the at least two rows of racks are in contact and a horizontally spaced-apart configuration wherein the walking space is defined between consecutive ones of the rows of racks.

In accordance with an embodiment, the vertically-extending posts have a plurality of vertically-spaced apart mounting apertures extending therethrough. The platform assembly further comprises bracket fasteners and the platform mounting brackets are detachably secured to the vertically-extending posts by inserting the bracket fasteners into respective ones of the mounting apertures defined in the vertically-extending posts.

In accordance with an embodiment, the platform mounting brackets are substantially U-shaped and comprise two flanges superposable to opposed sides of a respective one of the vertically-extending posts and a joining section connecting the two flanges together.

In accordance with an embodiment, each one of coupling apertures is open on the lower edge a respective one of the lateral sections of the frame.

In accordance with an embodiment, each one of the platform couplers comprises a protruding male member insertable into a corresponding one of the post coupling apertures.

In accordance with an embodiment, a first one of the post coupling apertures in a first one of the lateral end regions is substantially L-shape and comprises an insertion segment opened on the lower edge and a locking segment extending towards a lateral end of the first lateral end region.

In accordance with an embodiment, a second one of the post coupling apertures in a second one of the lateral end regions defines an oblique angle with the lower edge of the respective one of the lateral sections, having a closed end closer to a lateral end of the second lateral end region.

In accordance with an embodiment, the platform assembly further comprises a locking assembly selectively configurated in a locked configuration preventing engagement and disengagement of at least one of the post couplers with the corresponding platform mounting bracket and an unlocked configuration allowing engagement and disengagement of at least one of the post couplers with the corresponding platform mounting bracket.

In accordance with an embodiment, the locking assembly comprises at least one translatable catch slidably mounted to the frame of the platform in a respective one of the lateral end region and selectively obstructing a corresponding one of the post coupling apertures.

According to another general aspect, there is provided a method for detachably mounting a walking platform to a racking system that comprises at least two rows of racks configurable in a spaced-apart and substantially parallel configuration to define a walking space in between. The method comprises securing platform mounting brackets to vertically-extending posts of a respective frame of the rack of a first row of the at least two rows of racks and a respective frame of the rack of a second row of the at least two rows of racks, the vertically-extending posts of the first row and the second row delimitating the walking space, the platform mounting brackets being mounted at a same height. The method further comprises engaging first lateral end regions of lateral sections of a frame of the walking platform with the platform mounting brackets secured to the vertically-extending posts of the first row. The method further comprises pivoting second lateral end regions of the lateral sections of the frame of the walking platform above the platform mounting brackets secured to the vertically-extending posts of the second row. The method further comprises engaging the second lateral end regions of the lateral sections of the frame of the walking platform with the platform mounting brackets secured to the vertically-extending posts of the second row to configure the walking platform in a substantially horizontal and walkable configuration.

In an embodiment, each one of the platform mounting brackets comprises a post coupler including a post coupling aperture extending through a respective one of the lateral sections of the frame of the walking platform and wherein at least the post coupling aperture of the second lateral end region is opened at a lower edge thereof, wherein the first lateral end regions and the second lateral end regions are engaged with the platform mounting brackets by inserting the post couplers in a respective one of the post coupling apertures.

In an embodiment, the method further comprises locking at least one of the post couplers in the respective one of the post coupling apertures by translating a translatable catch in a locked configuration to obstruct the respective one of the post coupling apertures.

In accordance with still another general aspect, there is provided a racking system that comprises at least two rows of racks, a platform assembly and a ladder. The at least two rows of racks are configurable in a spaced-apart and substantially parallel configuration to define a walking space in between. Each one of the racks comprises a first side and a second side, opposed to the first side, a first pair of vertically-extending posts located on the first side and a second pair of vertically-extending posts located on the second side. The platform assembly comprises a walking platform and at least one ladder coupler. The walking platform has a frame with longitudinal sections and lateral sections and a walking panel mounted to the frame and defining a walking surface. Each one of the lateral sections has opposed lateral end regions. The walking platform is detachably securable to the vertically-extending posts of the first pair and the second pair on a side delimiting the walking space and configurable in a substantially horizontal and walkable configuration. The at least one ladder coupler is provided on at least one of the lateral sections of the frame of walking platform. The ladder comprises a frame with a platform mounting side and a platform coupler detachably engageable with the at least one ladder coupler when the platform is configured in the substantially horizontal and walkable configuration.

In accordance with an embodiment, at least one of the at least two rows of rack is horizontally displaceable towards and away from the other one of the at least two rows of racks and the at least two rows of racks are selectively configurable in a collapsed configuration wherein consecutive ones of the at least two rows of racks are in contact and in a horizontally spaced-apart configuration wherein the walking spaced is defined between consecutive ones of the at least two rows of racks.

In accordance with an embodiment, the vertically-extending posts have a plurality of vertically-spaced apart mounting apertures extending therethrough and the platform assembly further comprises bracket fasteners and platform mounting brackets, the platform mounting brackets are detachably secured to the vertically-extending posts by inserting the bracket fasteners into respective ones of the mounting apertures defined in the vertically-extending posts.

In accordance with an embodiment, the at least one ladder coupler comprises two ladder couplers, each one comprising a ladder coupling opening extending through the at least one of the lateral sections of the frame in a respective lateral end region thereof and the platform coupler comprises male members protruding from the plateform mounting side of the frame in an upper section thereof, the male members being selectively engageable and disengageable with a corresponding one of the ladder coupling openings.

In accordance with an embodiment, each one of the ladder coupling openings is pyriform.

In accordance with an embodiment, the platform assembly further comprises post couplers in each one of the lateral end regions of each one of the lateral sections of the frame of the walking platform, wherein each one of the post couplers comprises a post coupling aperture extending through a respective one of the lateral end regions, with at least one of the post coupling apertures being opened on a lower edge of the respective one of the lateral sections.

In accordance with an embodiment, the platform assembly further comprises a locking assembly selectively configuration in a locked configuration preventing engagement and disengagement of at least one of the post couplers with the corresponding platform mounting bracket and an unlocked configuration allowing engagement and disengagement of at least one of the post couplers with the corresponding platform mounting bracket, wherein the locking assembly comprises at least one translatable catch slidably mounted to the frame of the platform in a respective one of the lateral end region and selectively obstructing a corresponding one of the post coupling apertures.

### BRIEF DESCRIPTION OF THE DRAWINGS

FIG. 1 is a perspective view of a racking system in accordance with an embodiment;

FIG. 2 is a perspective view, enlarged, of a portion of the racking system shown in FIG. 1, showing an engagement between a platform and a frame of a rack of the racking system;

FIG. 3 is another perspective view, enlarged, of a portion of the racking system shown in FIG. 1, showing engagement between the platform and the frames of the racks located on both sides of the platform and wherein the platform is configured in a horizontal and walkable configuration;

FIG. 4 is a perspective view of the racking system shown in FIG. 1, wherein the platform is configured in a collapsed/substantially vertical configuration;

FIG. 5 is a perspective view of the racking system shown in FIG. 1, wherein the platform is configured in the horizontal and walkable configuration and a ladder is engaged therewith;

FIG. 6 is a perspective view of an upper section of the ladder shown in FIG. 5, showing platform couplers protruding from a platform mounting side;

FIG. 7 is a perspective view of a walking platform, in accordance with another embodiment, wherein the walking platform includes a locking assembly configured in a locked configuration;

FIG. 8 is a perspective view of the walking platform of FIG. 7, wherein the locking assembly is configured in an unlocked configuration;

FIG. 9 is a rear elevation view of a lateral section of a frame of the walking platform of FIG. 7, showing the locking assembly in the locked configuration;

FIG. 10 is a rear elevation view of the lateral section of the frame of the walking platform of FIG. 9, showing the locking assembly in the unlocked configuration;

FIG. 11 is a front elevation view of the lateral section of the frame of the walking platform of FIG. 9, showing the locking assembly in the locked configuration;

FIG. 12 is a front elevation view of the lateral section of the frame of the walking platform of FIG. 9, showing the locking assembly in the unlocked configuration; and

FIG. 13 is a perspective view of a section of a racking system including the walking platform of FIG. 7, wherein the locking assembly is configured in the unlocked configuration.

FIG. 14 is a flowchart of a method for mounting a platform to a racking system in accordance with an embodiment.

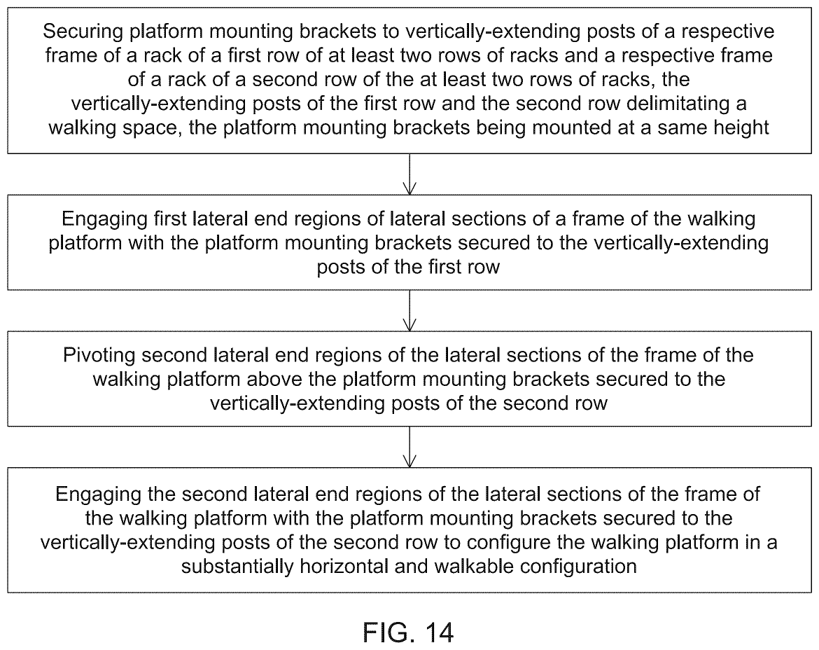

It will be noted that throughout the appended drawings, like features are identified by like reference numerals.

### DETAILED DESCRIPTION

Moreover, although the embodiments of the racking system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the racking system, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown figures are optional, and are given for exemplification purposes only.

Moreover, it will be appreciated that positional descriptions such as “above”, “below”, “forward”, “rearward” “left”, “right” and the like should, unless otherwise indicated, be taken in the context of the figures and correspond to the position and orientation of the racks of the racking system and corresponding parts when mounted to the floor and configured to support articles thereon. Positional descriptions should not be considered limiting.

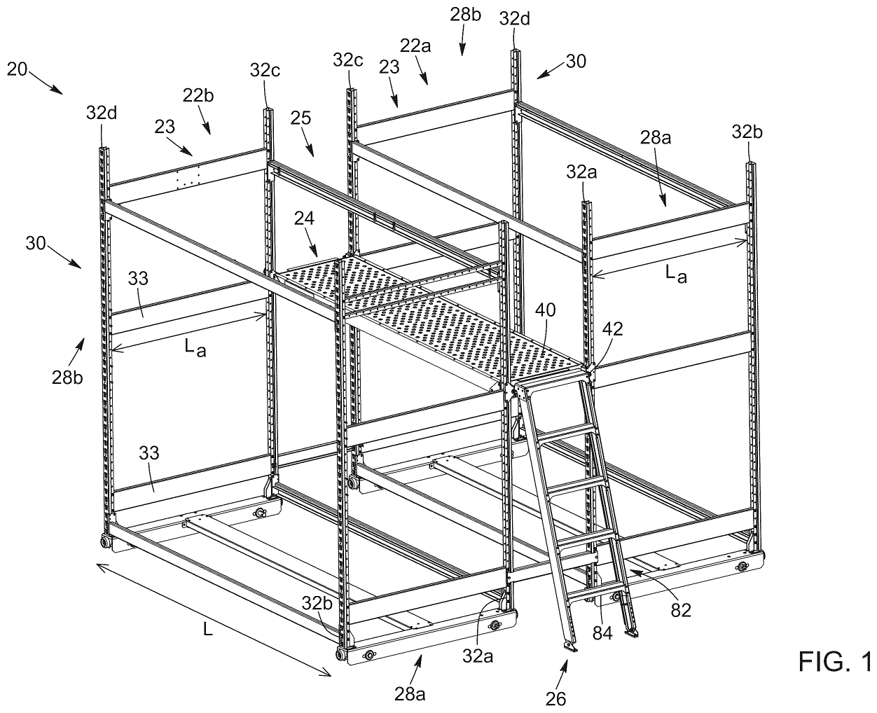

Referring now to FIG. 1, there is shown a non-limitative embodiment of a racking system 20 including two spaced-apart rows of racks 22a, 22b. In the non-limitative embodiment shown, the racking system 20 is a fixed racking system wherein the rows of racks 22a, 22b are mounted to a supporting surface (or ground), such as a floor. However, it is appreciated that, in an alternative embodiment (not shown), the racking system can be a mobile system wherein at least one of the rows of rack is mobile, e.g., it can translate with respect to the other rows of rack between a collapsed configuration and an extended configuration. More particularly, the mobile row(s) of rack is horizontally displaceable towards and away from the other one of the at least two rows of rack. For instance, the racking system can include elongated rails (not shown) fixed to the supporting surface and engaged by one or more rows of racks in such a manner that the rows of rack can be displaceable with respect to one another.

Therefore, in a mobile rack system, consecutive ones (or successively adjacent) of the rows of rack are selectively configurable in the collapsed configuration wherein they are in contact (or very close to one another) and a horizontally spaced-apart configuration wherein a walking space is defined therebetween, e.g., they are further spaced-apart than in the collapsed configuration. Therefore, it is possible to optimize the floor space of a storage facility by avoiding aisles/walking spaces being present between each two consecutive rows of rack to instead have a single aisle formed in a group composed of several rows of rack. The racks become horizontally stacked against each other (e.g., in the collapsed configuration), except where a walking space (or aisle) is formed.

In FIG. 1, only two rows of rack 22a, 22b are shown. However, it is appreciated that the racking system 20 can include more than two rows of rack extending substantially parallel to one another. Similarly, in FIG. 1, each one of the rows of racks 22a, 22b includes only one rack 23. However, it is appreciated that each one of the rows of racks 22a, 22b can include more than one rack disposed in a longitudinally extending arrangement, e.g., aligned along a longitudinal axis L.

In FIG. 1, the two rows of racks 22a, 22b are configured in a spaced-apart and substantially parallel configuration to define a walking space 25 in between.

In an embodiment wherein the racking system 20 is used for interior growing or indoor farming, the racks can be referred to as grow racks. However, it is appreciated that the racking system 20 can be used to other usage such as and without being limitative article storage.

In the embodiment shown in FIG. 1, in addition to the two rows of racks 22a, 22b, the racking system 20 comprises a platform assembly 24, extending into the walking space 25 and being mounted to the two horizontally spaced-apart racks 23, and a ladder 26 detachably coupled to the platform assembly 24 and providing access thereto.

The rack of the two rows of racks 22a, 22b being similar and including one rack 23, only one will be described in the following paragraphs.

Each one of the racks 23 has a first side 28a and a second side 28b, opposed to the first side. The first side 28a and the second side 28b are spaced-apart from one another along the longitudinal axis L of the rack 23 (or of the row of racks). Should the row of racks includes more than one rack, either the first side or the second side of the rack also constitute the first side or the second side of the adjacent one of the racks of the same row.

Each one of the racks 23 includes a frame 30 including a first pair of vertically-extending posts 32a, 32b located on the first side 28a and a second pair of vertically-extending posts 32c, 32d located on the second side 28b. The vertically-extending posts 32a, 32b are spaced-apart from one another along a lateral axis La of the rack 23, perpendicular to the longitudinal axis L. The vertically-extending posts 32c, 32d are also spaced-apart from one another along the lateral axis La. In the embodiment shown in FIG. 1, the vertically-extending posts 32a, 32c of the two adjacent ones of the rows delimit partially the walking space 25, e.g., they are located on the side of the walking space 25.

In the embodiment shown, the rack 23 is free of intermediate vertically-extending post. However, in an alternative embodiment (not shown), the rack 23 can include one or more vertically-extending post extending upwardly and being located between the two pairs of vertically-extending posts 32a, 32b, 32c, 32d located at the first and second sides 28a, 28b of the frame 30.

In the embodiment wherein the rack 23 is a mobile rack, it can further include support wheels and/or drive wheels (not shown) that are engageable with elongated rails and that are operatively connected to actuation mechanisms (not shown), as known in the art.

The frame 30 of the rack 23 also includes horizontally-extending beams 33 extending between the two vertically-extending posts of the pairs (32a, 32b), (32c, 32d), e.g., along the lateral axis La.

The rack 23 can further include vertically spaced and superimposed shelves (not shown) mounted to the frame 30 to receive articles such as e.g. boxes or plant trays (not shown).

It is appreciated that the racking system 20 can include other equipment (not shown), which are normally provided on fixed and/or mobile racking systems including but without being limited to aisle security systems, braking systems, etc.

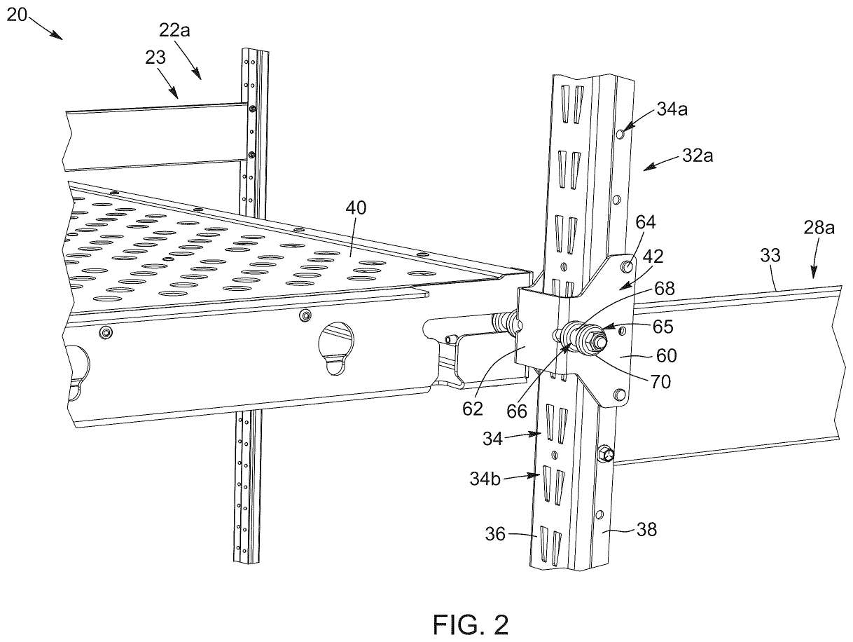

Referring now to FIG. 2, there is shown that each one of the vertically-extending posts 32a, 32b, 32c, 32d comprise vertically spaced-apart mounting apertures 34 on several sides thereof. In the non-limitative embodiment shown, each one of the vertically-extending posts 32a, 32b, 32c, 32d is substantially T-shaped with a transversal segment 36 extending along the longitudinal axis L and a central segment 38 extending transversally, along the lateral axis La and towards a center of the rack 23. A first set 34a of mounting apertures 34 extend through the central segment 38. A second set 34b of mounting apertures 34 extend through the transversal segment 36. In the non-limitative embodiment shown, the mounting apertures 34 of the second set 34b are provided in pair, one being located on each side of a center line corresponding to a junction with the central segment 38. It is appreciated that the configuration, the number, and the shape of the mounting apertures 34 can vary from the embodiment shown. Furthermore, it is appreciated that the vertically-extending posts can be free of mounting apertures 34.

In some implementations, the mounting apertures 34 defined in the vertically-extending posts of one of the racks 23 are vertically aligned together.

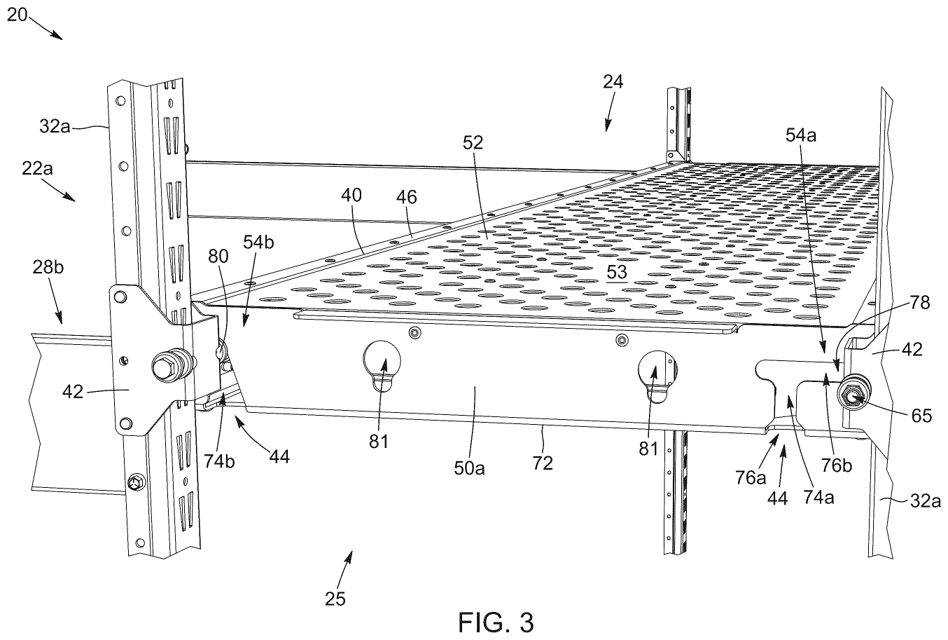

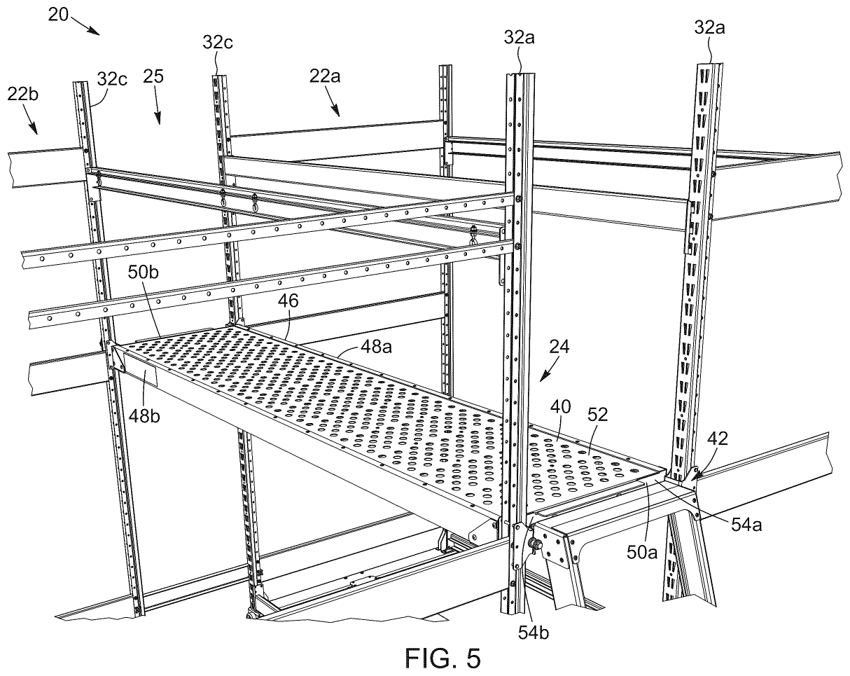

Referring now to FIGS. 3 and 5, the platform assembly 24 will be described in further detail. In the non-limitative embodiment shown, it includes a walking platform 40, platform mounting brackets 42 securable to the vertically-extending posts 32a, 32c of the first pair and the second pair on a side delimiting the walking space 25 at a same height, and post couplers 44.

In the non-limitative embodiment shown, the racking system 20 includes only one platform assembly 24 with only one walking platform. It is appreciated that, in alternative embodiments (not shown), the racking system 20 can include more than one platform assembly 24 and/or the platform assembly 24 can include more than one platform 40.

The walking platform 40 is detachably securable to two consecutive rows of rack 22a, 22b above the supporting surface (or ground) and is configured to support a person above the ground. Therefore, the platform can provide access, to a user, to upper shelf areas, located on either side of the walking space 25, when the racks are of a height above human height.

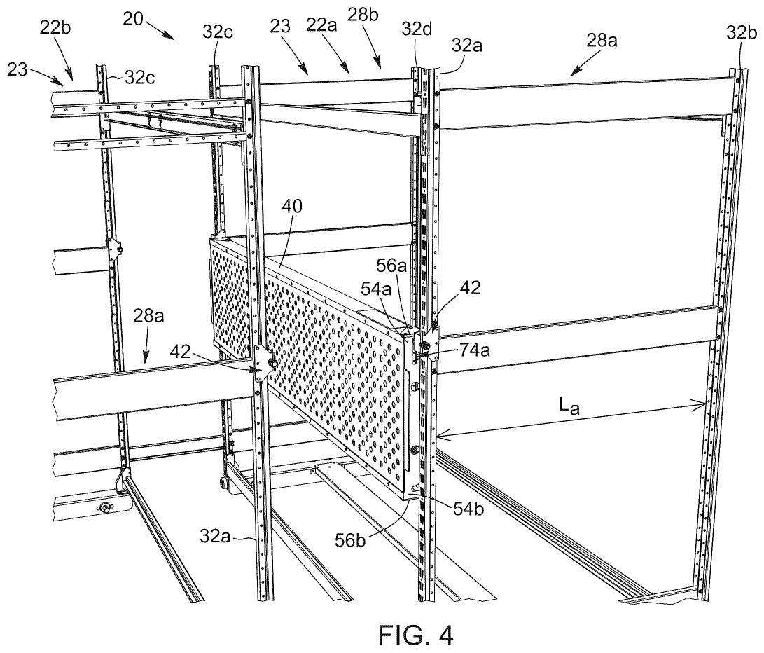

The walking platform 40 has a frame 46 with longitudinal sections 48a, 48b and lateral sections 50a, 50b and a walking panel 52 (or upper panel) mounted to the frame 46 and defining a walking surface 53. Each one of the lateral sections 50a, 50b has opposed lateral end regions 54a, 54b, each one being adjacent to a respective one of the rows of racks 22a, 22b, when the walking platform 40 is mounted thereto in an operative/substantially horizontal and walkable configuration, as shown in FIGS. 1, 3, and 5. Each one of the lateral end regions 54a, 54b extends inwardly from a respective lateral end 56a, 56b (FIG. 4) of the respective one of the lateral sections 50a, 50b.

In the embodiment shown, the platform mounting brackets 42 are detachably secured to a respective one the vertically-extending posts 32a, 32c of the first pair and the second pair on the side delimiting the walking space 25. In the non-limitative embodiment shown, the platform assembly 24 further includes bracket fasteners (not shown) engageable with a pair of the platform mounting brackets 42 and the vertically-extending posts 32a, 32c to detachably attached the platform mounting brackets 42 at a selected height along and to the vertically-extending post 32a, 32c.

In a non-limitative embodiment, the platform mounting brackets 42 are detachably secured to the vertically-extending posts 32a, 32c by inserting the bracket fasteners into respective ones of the mounting apertures 34 defined in the central segment 38 of vertically-extending posts 32a, 32c, e.g., the second set 34b of mounting apertures.

In the non-limitative embodiment shown, each one of the vertically-extending posts 32a, 32c includes only one platform mounting bracket 42. However, it is appreciated than, in an alternative embodiment (not shown), each one of the vertically-extending posts 32a, 32c can include more than one platform mounting brackets 42, vertically spaced-apart from one another. Furthermore, it is appreciated that, platform mounting brackets 42 can be mounted to the vertically-extending posts 32b, 32d, for instance if they are located adjacent to another row of racks 22.

Referring now to FIG. 2, in the non-limitative embodiment shown, the platform mounting brackets 42 are substantially U-shaped and comprise two flanges 60 (only one is shown) superposable to opposed sides of a respective one of the vertically-extending posts 32a, 32c and a joining section (or joining plate) 62 connecting the two flanges 60 together.

In the non-limitative embodiment shown, each one of the flanges 60 has a post mounting aperture 64 extending therethrough. The post mounting apertures 64 of each one of the platform mounting brackets 42 are aligned. In the non-limitative embodiment shown, the opposed sides of a respective one of the vertically-extending posts 32a, 32c are adjacent to the flanges 60 and are connectable by a bolt or a pin extending through a pair of aligned post mounting apertures 64 and apertures in the opposed sides of the vertically-extending posts 32a, 32c.

Each one of the platform mounting brackets 42 further includes a platform coupler 65. In the non-limitative embodiment shown, the platform coupler 65 is engaged with the flanges 60 by extending through a pair of aligned apertures.

More particularly, in the non-limitative embodiment shown, the platform coupler 65 includes a bolt extending through the pair of aligned apertures and having at least one end section extending outwardly past a respective one of the flanges 60 and defining a protruding abutment 66 (or male member), engageable with the platform 40, as will be described in more details below. In the non-limitative embodiment shown, the platform coupler 65 has end sections extending outwardly past the flanges 60 on both sides thereof. Therefore, each one of platform mounting brackets 42 includes two protruding abutments 66, one on each side thereof.

In an alternative embodiment (not shown), the platform coupler 65 can be single piece with a remaining portion of the platform mounting bracket 42.

In the non-limitative embodiment shown, in each one of the end sections protruding outwardly from the flanges 60 of the platform mounting brackets 42, the platform coupler 65 has a narrower stem 68 and a larger head 70, located outwardly of the narrower stem 68. The purpose of which will be describe in more details below.

It is appreciated that, in an alternative embodiment, the shape and the configuration of the platform mounting brackets 42 and its platform coupler 65 can vary from the embodiment shown. For instance and without being limitative, the platform mounting brackets. can be mounted to the vertically-extending posts 32a, 32c with a different fastening assembly than the bracket fasteners.

Turning now to FIG. 3, non-limitative embodiments of the post couplers 44 will be described. The post couplers 44 are provided on each one of the lateral sections 50a, 50b of the frame 46 of walking platform 40 and, more particularly, in each one of the lateral end regions 54a, 54b.

In the non-limitative embodiment shown, since the platform couplers 65 include the protruding male members 66, the post couplers 44 include complementary female members. However, it is appreciated that, in an alternative embodiment (not shown), the platform couplers 65 can be female member and the post couplers 44 are complementary male members.

In the non-limitative embodiment shown, each one of the post couplers 44 includes a post coupling aperture extending through a respective one of the lateral sections 50a, 50b of the frame 46 of the platform 40. Each one of the post coupling apertures is open on a lower edge 72 of the respective one of the lateral sections 50a, 50b and engageable by a corresponding one of the platform coupler 65.

The post coupler 44 provided on each one of the lateral sections 50a, 50b of the frame 46 being similar, only one will be described in the following paragraphs.

A first one of the post coupling apertures is located in a first one of the lateral end regions 54a and is substantially L-shape. It is also referred to as the engagement coupling aperture 74a since it is the first one to be engaged with a corresponding one of the platform couplers 65. It includes an insertion segment 76a opened on the lower edge 72 and a locking segment 76b extending towards a respective one of the lateral ends 56a of the lateral end region 54a. The insertion segment 76a and the locking segment 76b communicate, with the locking segment 76b having a closed end 78. A corresponding one of the platform coupler 65 is engageable in the engagement coupling aperture 74a, from an open end thereof located at the lower edge 72, and slidably therein until it reaches the closed end 78. A width of the engagement coupling aperture 74a is slightly wider than a diameter of the stem 68 of the platform coupler 65 to allow its displacement therealong but narrower than a diameter of the head 70 of the platform coupler 65 to prevent its disengagement once engaged and configured in the operative/substantially horizontal and walkable configuration.

A second one of the post coupling apertures 74b is located in a second one of the lateral end regions 54b. It defines an oblique angle with the lower edge 72, having a closed end 80 closer to the respective one of the lateral ends 56b of the lateral end region 54b.

As for the engagement coupling aperture 74a, a corresponding one of the platform coupler 65 (e.g., the platform coupler 65 facing the one inserted in the first post coupling aperture 74a on the opposite side of the walking space 25) is engageable in the second post coupling aperture 74b, from an open end thereof located at the lower edge 72, and slidably therein until it reaches the closed end 80. To engage the platform coupler 65 in the second post coupling aperture 74b, the platform 40 is pivoted upwardly about the platform coupler 65 engaged in the engagement coupling aperture 74a until the lateral end region 54b is located above the corresponding platform coupler 65. Then, the opening of the second post coupling aperture 74b, on the lower edge 72, is aligned with the platform coupler 65 and the platform 40 is pivoted downwardly to engage the platform coupler 65 inside the second post coupling aperture 74b until it reaches the closed end 80. Then, the platform 40 is configured in the operative/substantially horizontal and walkable configuration, secured to the vertically extending posts 32a, 32c of the two rows of racks 22a, 22b.

As for the engagement coupling aperture 74a, a width of the second post coupling aperture 74b is slightly wider than a diameter of the stem 68 of the platform coupler 65 to allow its displacement therealong but narrower than a diameter of the head 70 of the platform coupler 65 to prevent its disengagement once engaged and configured in the operative/substantially horizontal and walkable configuration.

Even though the above-description refers to the platform coupler 65 and the engagement coupling apertures 74a, 74b on one side of the rack 22, it is understood that the platform couplers 65 on the first side 28a and the second side 28b are inserted simultaneously with the engagement coupling apertures 74a, 74b located at the two opposed lateral sections 50a, 50b of the platform 40.

The same steps can be processed, in a reverse order, to disengage the platform 40 from at least one of the two rows of racks 22a, 22b. In an embodiment, the platform 40 can be mounted to only one of the two rows of racks 22a, 22b, via the engagement coupling apertures 74a, as shown in FIG. 4. When mounted to only one of the two rows of racks 22a, 22b, the platform 40 can be configurable in a collapsed/vertical configuration, wherein the platform is superposed to the rows of racks to which it is mounted. In some implementations, a length of the platform 40, along the longitudinal axis L, is shorter than a distance between the two vertically-extending posts 32a, 32c to which the platform 40 is mounted. Therefore, if the racking system is mobile, the rows of racks 22a, 22b can be further compacted even if the platform 40 remains mounted to one of the rows of racks 22a, 22b in the collapsed configuration thereof.

In the embodiment shown, the two post coupling apertures 74a, 74b of each one of the lateral sections 50a, 50b of the frame 46 are opened at the lower edge 72 of the lateral section 50a, 50b. It is appreciated that, in an alternative embodiment (not shown), only one of the post coupling apertures 74a, 74b can be opened at the lower edge 72. For instance, the first post coupling aperture 74a can be a pyriform aperture and the second post coupling aperture 74b can be opened at the lower edge 72.

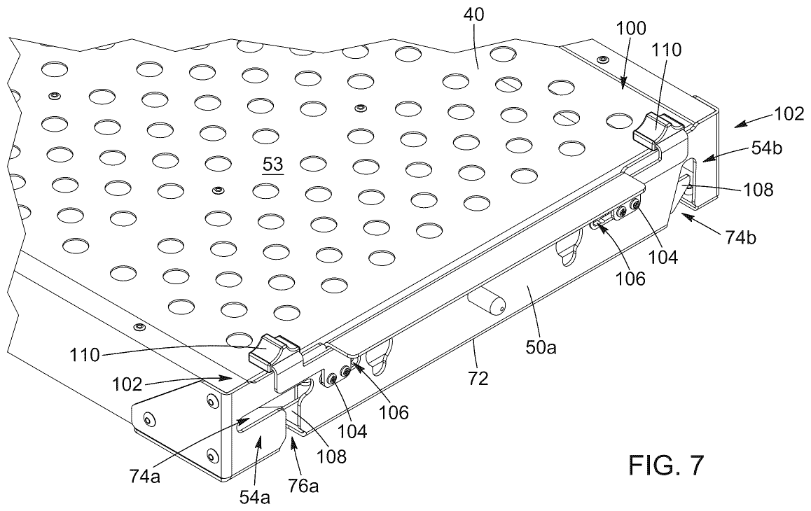

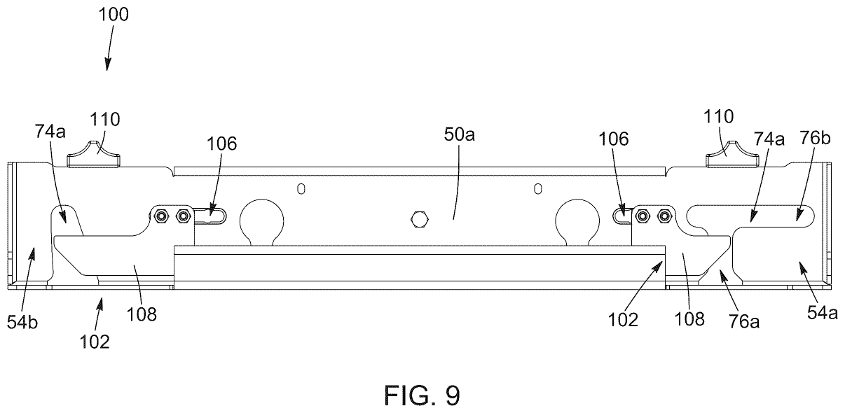

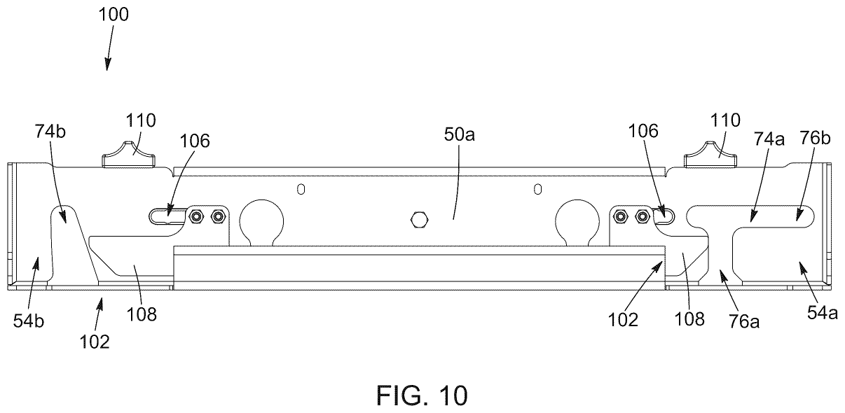

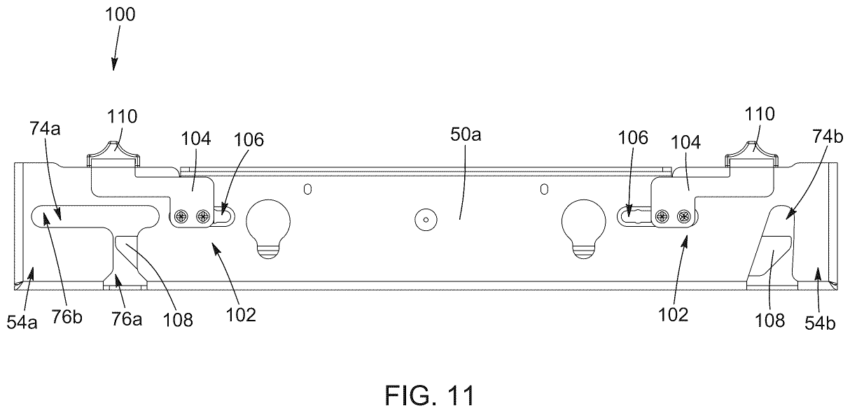

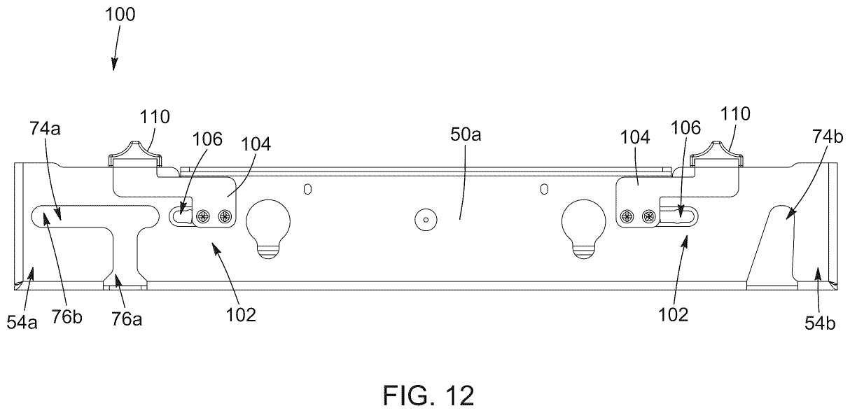

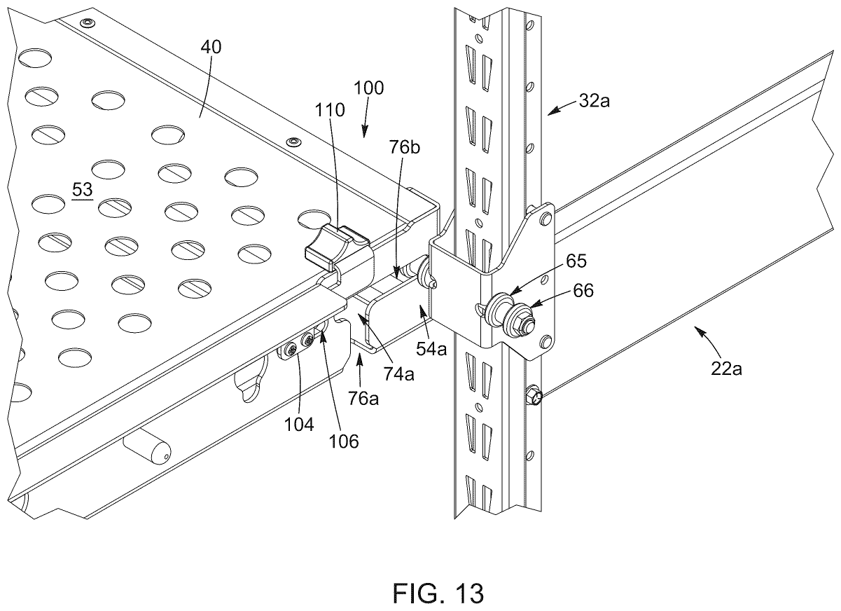

Referring now to FIGS. 7 to 13, there is shown an alternative embodiment of the platform assembly 24, similar to the one described above in reference to FIGS. 1 to 6, and further including a locking assembly 100 configured to temporary lock the platform assembly 24 to the spaced-apart rows of racks 22a, 22b, e.g., prevent inadvertent disengagement.

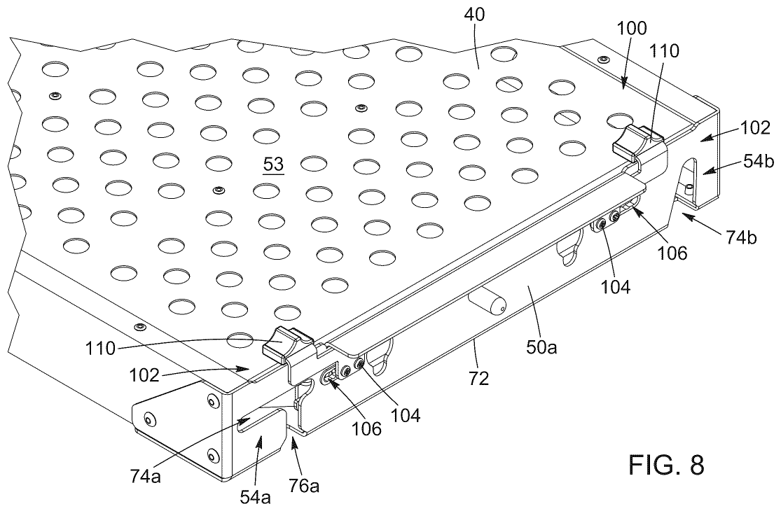

In the non-limitative embodiment shown, the locking assembly 100 comprises two translatable catches 102 mounted to the platform 40, one in each of the first and the second lateral end regions 54a, 54b. The purpose of each translatable catches 102 is to selectively allow engagement and prevent disengagement of the platform coupler 65 into a respective one of the engagement coupling apertures 74a, 74b. The translatable catches 102 are mounted to the lateral sections 50a, 50b of the platform 40. However, it is appreciated that, in other embodiments (not shown), the translatable catches 102 can be mounted to other components of the platform assembly 24 or other components the spaced-apart rows of racks 22a, 22b, such as and without being limitative, the platform mounting brackets 42 or the vertically-extending posts 32a, 32c. As will be described in more details below, each one of the translatable catches 102 includes a section superposed to the lateral section 50a, 50b and a section superposed to the walking panel 52. Each one of the translatable catches 102 is selectively configurable into two configurations: an unlocked configuration (see FIGS. 8, 10, 12 and 13) and a locked configuration (see FIGS. 7, 9 and 11). In the unlocked configuration, one platform coupler 65 can be inserted in and disengaged from the respective one of the engagement coupling apertures 74a, 74b. In the locked configuration, one platform coupler 65 cannot be inserted or disengaged from the respective one of the engagement coupling apertures 74a, 74b. In the embodiment shown, each translatable catch 102 is configurable in a selected one of the locked and unlocked configurations, independently of the others translatable catches 102 of the platform assembly 24. It is understood that in other embodiments, all the translatable catches can be configured in the unlocked and the locked configurations independently from one another. In an alternative embodiment, the translatable catches can be configured at the same time (e.g., simultaneously) in the locked or the unlocked configurations.

A non-limitative embodiment of the translatable catch 102 will now be described in further details. The two translatable catches 102, provided at opposed ends of the lateral sections 50a, 50b of the platform 40 being substantially similar, only one will be described.

For each one of the translatable catches 102, the lateral sections 50a, 50b of the platform 40 has a sliding slot 106 defined therein, in the first and the second lateral end regions 54a, 54b respectively. The sliding slot 106 extends parallel to the lower edge 72 and has, for example, an obround shape. The translatable catch 102 is mounted to the platform 40 via a respective one of the sliding slots 106 and is translatable therein, as will be described in more details below.

The translatable catch 102 comprises an outer base 104 superposed outwardly to the lateral sections 50a, 50b, a handle 110 superposed to the walking surface 53, outwardly thereof, and a slide lock 108 superposed inwardly to the lateral sections 50a, 50b. The slide lock 108 is connected to the outer base 104 via two mechanical fasteners extending through the sliding slot 106 and slidable therein. In the locked and unlocked configurations, the slide lock 108 respectively obstruct and free the opening of the engagement coupling aperture 74a, 74b to prevent or allow passage of the respective one of the platform coupler 65. Therefore, the slide lock 108 is moveable between an open position and a closed position, corresponding respectively to the unlocked and locked configurations of the translatable catch 102. For the engagement coupling aperture 74a, in the locked configuration of the translatable catch 102, the slide lock 108 obstructs the insertion segment 76a.

To selectively configure the translatable catch 102 in the locked configuration or the unlocked configuration, the handle 110 can be manipulated by translating same along the walking surface 53.

It is understood that, in other embodiments (not shown), the locking assembly 100 and/or the translatable catches 102 can differ from the embodiment shown. For instance and without being limitative, they can include a pivotable actuator or a different linear actuator from the one shown, or other suitable actuation mechanism. The translatable catches 102 can also be spring loaded in the locked configuration by including a biasing member. In other words, the sliding lock 108 can be biased in the locked configuration by a biasing member, such as a spring, and an voluntary action must be taken by a user to configure it into the unlocked configuration to either inserted in or disengage the platform couplers 65 from the post couplers 44.

As mentioned above, in some implementations, the racking system 20 further includes one or more ladder 26 (only one is shown in FIG. 1).

In such implementation, as shown in FIG. 3, the platform assembly 24 can include at least one ladder coupler 81 provided on at least one of the lateral sections 50a, 50b of the frame 46 of walking platform 40. In an embodiment, the ladder coupler(s) can be provided at both lateral end regions 54a, 54b.

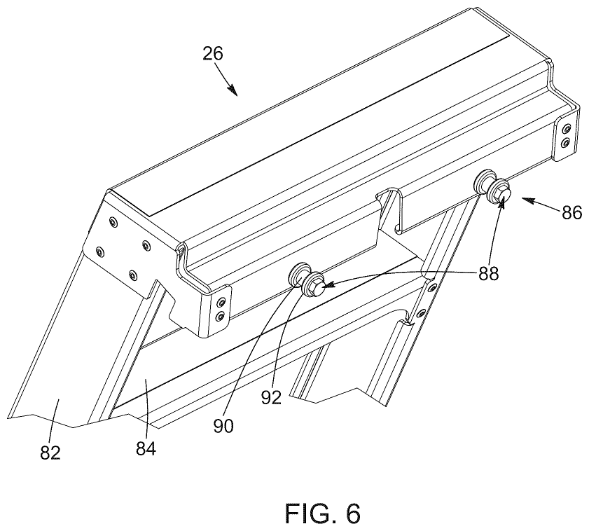

In the embodiment shown in FIGS. 1 and 6, the ladder 26 includes a frame 82 with a plurality of steps 84, a platform mounting side 86, and a platform coupler 88 detachably engageable with the at least one ladder coupler 81, as will be described in more details below.

In the non-limitative embodiment shown, the platform assembly 24 includes two ladder couplers 81, located in (or adjacent to) a respective one of the lateral end regions 54a, 54b, and the platform coupler 88 comprises two horizontally spaced-apart platform couplers 88. In the non-limitative embodiment shown, the ladder couplers 81 are female members and, more particularly, include ladder coupling openings extending through the lateral section 50a, 50b of the frame 46, inwardly of the post couplers 44. In the non-limitative embodiment shown, the ladder coupling openings 81 are pyriform, e.g., pear-shaped, with a larger upper substantially-circular section and a narrower semi-circular section.

The platform couplers 88 are complementary male members protruding from the ladder frame 82, on the platform mounting side 86. The platform couplers 88 are substantially similar to a section of the platform couplers 65 and, more particularly, the section protruding outwardly of the flanges 60 of the platform mounting brackets 42. More particularly, they include a narrower stem 90 and a larger head 92.

The upper substantially-circular section of the ladder coupling openings 81 have a diameter greater than a diameter of the head 92 of the platform couplers 88 to be insertable therethrough. The semi-circular section has a diameter greater than a diameter of the stem 90 but smaller than a diameter of the head 92 of the platform couplers 88 to prevent undesired disengagement between each pair of the platform couplers 88 and the ladder couplers 81.

In the non-limitative embodiment shown, the ladder 26 includes male members as platform couplers 88 and the platform assembly 24 includes complementary female members. It is appreciated that, in an alternative embodiment (not shown), the ladder 26 can include the female members and the platform assembly 24 can include the complementary male members.

In the non-limitative embodiment shown, each one of the ladder 26 and the platform assembly 24 includes two spaced-apart platform and ladder couplers 88, 81. However, it is appreciated that, in alternative embodiments (not shown), each one of the ladder 26 and the platform assembly 24 can include only one or more than two platform and ladder couplers 88, 81.

It is appreciated that the shape and the configuration of the platform and ladder couplers 88, 81 can vary from the embodiment shown, provided that they are selectively engageable and disengageable together.

There is also provided a method for detachably mounting the walking platform 40 to the racking system 20 described above, between two consecutive rows of racks 22a, 22b.

The consecutive rows of racks 22a, 22b, e.g., a first row and a second row, are first configured in a horizontally spaced-apart configuration with the walking space 25 defined inbetween.

The platform mounting brackets 42 are secured to vertically-extending posts 32a, 32c of the frames 30 of the racks of the first row and the second row. The platform mounting brackets 42 can be secured to the vertically-extending posts 32a, 32c before configuring same in the horizontally spaced-apart configuration. For instance, they can be secured once at a selected height and remain there. As mentioned above, at least four platform mounting brackets 42 of the first and the second rows 22a, 22b are mounted at the same height, e.g., two on each one of the rows 22a, 22b.

The first lateral end regions 54a of lateral sections 50a of the frame 46 of the walking platform 40 are engaged with the platform mounting brackets 42 secured to the vertically-extending posts 32a, 32c of the first row 22a.

Then, the second lateral end regions 54b of the lateral sections 50b of the frame 46 of the walking platform 40 are pivoted above the platform mounting brackets 42 secured to the vertically-extending posts 32a, 32c of the second row 22b. The second lateral end regions 54b of the lateral sections 50b of the walking platform 40 are then engaged with the platform mounting brackets 42 secured to the vertically-extending posts 32a, 32c of the second row 22b by pivoting downwardly the walking platform 40 to configure the walking platform 40 in a substantially horizontal and walkable configuration.

The platform 40 can be configured in the collapsed/substantially vertical configuration by disengaging the second lateral end regions 54b of the lateral sections 50b of the walking platform 40 from the platform mounting brackets 42 secured to the vertically-extending posts 32a, 32c of the second row 22b and pivoting the platform 40 downwardly about the first lateral end regions 54a engaged with the platform mounting brackets 42 secured to the vertically-extending posts 32a, 32c of the first row 22a.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A racking system comprising:
at least two rows of racks configurable in a spaced-apart and substantially parallel configuration to define a walking space in between, each one of the racks comprising a first side and a second side, opposed to the first side, a first pair of vertically-extending posts located on the first side and a second pair of vertically-extending posts located on the second side; and
a platform assembly comprising:
a walking platform having a frame with longitudinal sections and lateral sections and a walking panel mounted to the frame and defining a walking surface, each one of the lateral sections having opposed lateral end regions;
platform mounting brackets securable to the vertically-extending posts of the first pair and the second pair on a side delimiting the walking space at a same height, each one of the platform mounting brackets having a platform coupler; and
post couplers provided on each one of the lateral sections of the frame of the walking platform in each one of the lateral end regions, each one of the post couplers comprising a post coupling aperture extending through a respective one of the lateral sections of the frame of the walking platform, the post couplers being engageable with a respective one of the platform couplers of the platform mounting brackets to configure the walking platform in a substantially horizontal and walkable configuration, wherein at least one of the post coupling apertures of each one of the lateral sections of the frame is open on a lower edge thereof.

2. The racking system of claim 1, wherein at least one of the at least two rows of racks is horizontally displaceable towards and away from the other one of the at least two rows of racks and the at least two rows of racks are selectively configurable in a collapsed configuration wherein consecutive ones of the at least two rows of racks are in contact and a horizontally spaced-apart configuration wherein the walking space is defined between consecutive ones of the rows of racks.

3. The racking system of claim 1, wherein the vertically-extending posts have a plurality of vertically-spaced apart mounting apertures extending therethrough, the platform assembly further comprises bracket fasteners and the platform mounting brackets are detachably secured to the vertically-extending posts by inserting the bracket fasteners into respective ones of the mounting apertures defined in the vertically-extending posts.

4. The racking system of claim 1, wherein the platform mounting brackets are substantially U-shaped and comprise two flanges superposable to opposed sides of a respective one of the vertically-extending posts and a joining section connecting the two flanges together.

5. The racking system of claim 1, wherein each one of coupling apertures is open on the lower edge a respective one of the lateral sections of the frame.

6. The racking system of claim 1, wherein each one of the platform couplers comprises a protruding male member insertable into a corresponding one of the post coupling apertures.

7. The racking system of claim 6, wherein a first one of the post coupling apertures in a first one of the lateral end regions is substantially L-shape and comprises an insertion segment opened on the lower edge and a locking segment extending towards a lateral end of the first lateral end region.

8. The racking system of claim 7, wherein a second one of the post coupling apertures in a second one of the lateral end regions defines an oblique angle with the lower edge of the respective one of the lateral sections, having a closed end closer to a lateral end of the second lateral end region.

9. The racking system of claim 1, wherein the platform assembly further comprises a locking assembly selectively configurated in a locked configuration preventing engagement and disengagement of at least one of the post couplers with the corresponding platform mounting bracket and an unlocked configuration allowing engagement and disengagement of at least one of the post couplers with the corresponding platform mounting bracket.

10. The racking system of claim 9, wherein the locking assembly comprises at least one translatable catch slidably mounted to the frame of the platform in a respective one of the lateral end region and selectively obstructing a corresponding one of the post coupling apertures.

11. A method for detachably mounting a walking platform to a racking system comprising at least two rows of racks configurable in a spaced-apart and substantially parallel configuration to define a walking space in between, the method comprising:
securing platform mounting brackets to vertically-extending posts of a respective frame of the rack of a first row of the at least two rows of racks and a respective frame of the rack of a second row of the at least two rows of racks, the vertically-extending posts of the first row and the second row delimitating the walking space, the platform mounting brackets being mounted at a same height;
engaging first lateral end regions of lateral sections of a frame of the walking platform with the platform mounting brackets secured to the vertically-extending posts of the first row;
pivoting second lateral end regions of the lateral sections of the frame of the walking platform above the platform mounting brackets secured to the vertically-extending posts of the second row;
engaging the second lateral end regions of the lateral sections of the frame of the walking platform with the platform mounting brackets secured to the vertically-extending posts of the second row to configure the walking platform in a substantially horizontal and walkable configuration.

12. The method of claim 11, wherein each one of the platform mounting brackets comprises a post coupler including a post coupling aperture extending through a respective one of the lateral sections of the frame of the walking platform and wherein at least the post coupling aperture of the second lateral end region is opened at a lower edge thereof, wherein the first lateral end regions and the second lateral end regions are engaged with the platform mounting brackets by inserting the post couplers in a respective one of the post coupling apertures.

13. The method of claim 12, further comprising locking at least one of the post couplers in the respective one of the post coupling apertures by translating a translatable catch in a locked configuration to obstruct the respective one of the post coupling apertures.

14. A racking system comprising:
at least two rows of rack configurable in a spaced-apart and substantially parallel configuration to define a walking space in between, each one of the racks comprising a first side and a second side, opposed to the first side, a first pair of vertically-extending posts located on the first side and a second pair of vertically-extending posts located on the second side;
a platform assembly comprising:
a walking platform having a frame with longitudinal sections and lateral sections and a walking panel mounted to the frame and defining a walking surface, each one of the lateral sections having opposed lateral end regions, the walking platform being detachably securable to the vertically-extending posts of the first pair and the second pair on a side delimiting the walking space and configurable in a substantially horizontal and walkable configuration; and
at least one ladder coupler provided on at least one of the lateral sections of the frame of walking platform; and
a ladder comprising a frame with a platform mounting side and a platform coupler detachably engageable with the at least one ladder coupler when the platform is configured in the substantially horizontal and walkable configuration.

15. The racking system of claim 14, wherein at least one of the at least two rows of rack is horizontally displaceable towards and away from the other one of the at least two rows of racks and the at least two rows of racks are selectively configurable in a collapsed configuration wherein consecutive ones of the at least two rows of racks are in contact and in a horizontally spaced-apart configuration wherein the walking spaced is defined between consecutive ones of the at least two rows of racks.

16. The racking system of claim 14, wherein the vertically-extending posts have a plurality of vertically-spaced apart mounting apertures extending therethrough and the platform assembly further comprises bracket fasteners and platform mounting brackets, the platform mounting brackets are detachably secured to the vertically-extending posts by inserting the bracket fasteners into respective ones of the mounting apertures defined in the vertically-extending posts.

17. The racking system of claim 14, wherein the at least one ladder coupler comprises two ladder couplers, each one comprising a ladder coupling opening extending through the at least one of the lateral sections of the frame in a respective lateral end region thereof and the platform coupler comprises male members protruding from the plateform mounting side of the frame in an upper section thereof, the male members being selectively engageable and disengageable with a corresponding one of the ladder coupling openings.

18. The racking system of claim 17, wherein each one of the ladder coupling openings is pyriform.

19. The racking system of claim 14, wherein the platform assembly further comprises post couplers in each one of the lateral end regions of each one of the lateral sections of the frame of the walking platform, wherein each one of the post couplers comprises a post coupling aperture extending through a respective one of the lateral end regions, with at least one of the post coupling apertures being opened on a lower edge of the respective one of the lateral sections.

20. The racking system of claim 19, wherein the platform assembly further comprises a locking assembly selectively configuration in a locked configuration preventing engagement and disengagement of at least one of the post couplers with the corresponding platform mounting bracket and an unlocked configuration allowing engagement and disengagement of at least one of the post couplers with the corresponding platform mounting bracket, wherein the locking assembly comprises at least one translatable catch slidably mounted to the frame of the platform in a respective one of the lateral end region and selectively obstructing a corresponding one of the post coupling apertures.
